(19) United States
(12) Patent Application Publication
(10) Pub. No.: US 2023/0091195 A1
(43) Pub. Date: Mar. 23, 2023

(54) FLOW OFFLOADING METHOD FOR A PROGRAMMABLE NETWORK INTERFACE CONTROLLER (NIC)

(71) Applicant: Intel Corporation, Santa Clara, CA (US)

(72) Inventors: Qi ZHANG, Shanghai (CN); Ping YU, Shanghai (CN); Ting XU, Wenzhou (CN); Junfeng GUO, Shanghai (CN); Kevin C. SCOTT, Forest Grove, OR (US); Dan NOWLIN, Hillsboro, OR (US)

(21) Appl. No.: 18/072,498

(22) Filed: Nov. 30, 2022

(30) Foreign Application Priority Data
Nov. 7, 2022 (WO) PCT/CN2022/130215

(51) Int. Cl. H04L 69/22; H04L 49/90; H04L 49/1546

(52) U.S. Cl. CPC H04L 69/22; H04L 49/90; H04L 49/1546

(57) ABSTRACT

Examples described herein relate to a driver that is to: determine a configuration of a packet processing pipeline of a network interface device to perform an instruction set written in a domain specific language (DSL) for the packet processing pipeline based on emulation or analysis of a parser of the packet processing pipeline and provide the configuration to the packet processing pipeline of the network interface device to specify operations of the packet processing pipeline of the network interface device.

### RELATED APPLICATION

This application claims the benefit of priority to Patent Cooperation Treaty (PCT) Application No. PCT/CN2022/130215, filed Nov. 7, 2022. The entire contents of that application are incorporated by reference in its entirety.

### BACKGROUND

Network interface controllers (NICs) or other devices can include a programmable packet processing pipeline to accelerate processing of various network workloads. Device drivers for NICs are to provide access to flow processing operations performed by the packet processing pipeline. However, if capabilities of the NIC change, such as capabilities are removed, modified, or are added, the associated device driver is also to be changed. In some cases, a NIC includes or can access one or more processors or accelerators to perform operations and if some operations are to be shifted to be performed by the one or more processors or accelerators, then associated driver design is also to be changed. Device driver re-design can be time consuming and lead to inability to access and utilize operations of a NIC or other devices.

### BRIEF DESCRIPTION OF THE DRAWINGS

FIG. 1 depicts an example overview of a system.

FIG. 2 depicts an example overview of hardware offload capabilities.

FIG. 3 depicts an example system.

FIG. 4 depicts an example parse graph of program execution routines.

FIG. 5 depicts an example rule sculpturing.

FIG. 6 depicts an example operation of a parser emulator.

FIG. 7 depicts an example of parser logic representation file.

FIG. 8 depicts an example process.

FIG. 9 network interface device.

FIG. 10 depicts an example system.

### DETAILED DESCRIPTION

At least to provide for flexibility to provide access to processing capabilities of a NIC or other device despite changes to processing operations performed by the NIC, a driver can flexibly configure a NIC hardware parser to support processing operations without modification of the driver. The driver can learn hardware capabilities of the NIC at runtime and translate an instruction set to configure a programmable packet processing pipeline of the NIC to perform the packet processing logic described by the instruction set. For example, the driver can receive a packet processing instruction set described by a Domain Specific Language (DSL) and translate DSL instructions into a hardware command representation to be performed by the NIC. Translating DSL instructions into a hardware command representation can include: (1) DSL command analysis (e.g., packet filter analyzer), (2) a rule sculpting, (3) parser emulation, and (4) configuring the NIC or other device with a parser logic representation based on parser emulation.

In some examples, the driver can setup an exception path handling to be performed by one or more processors of or accessible to the NIC to perform operations of DSL commands that the NIC is not able to perform or is configured to offload to the one or more processors, such as for load balancing. For example, operations related to new or changes to protocols (e.g., revisions to IEEE 802.3) can be performed by the programmable packet processing pipeline of the NIC by use of the driver that can learn hardware capabilities, such as parser operation, at runtime and that accepts a DSL to configure the programmable packet processing pipeline of the NIC to perform packet filter logic of the DSL.

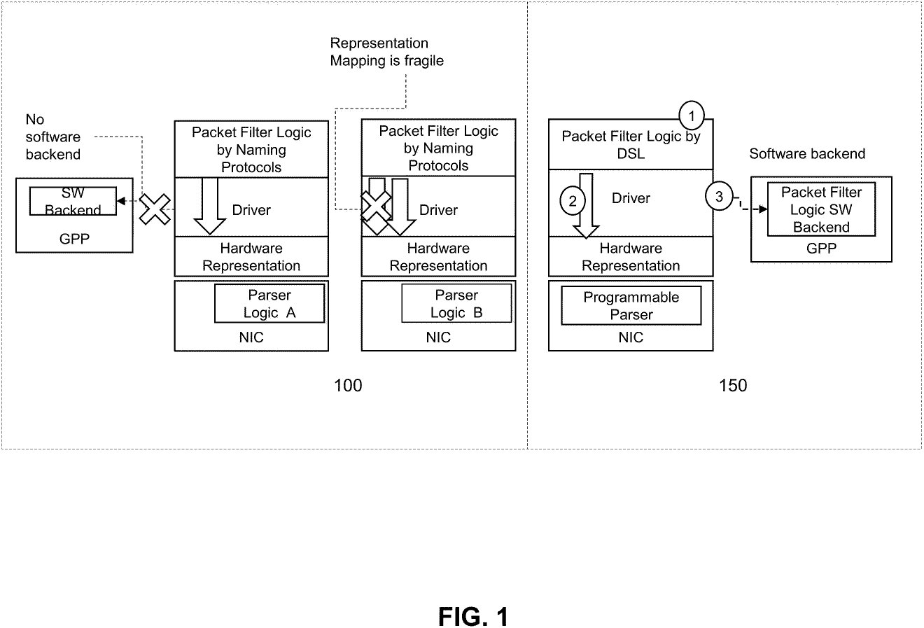

FIG. 1 depicts an example overview of a system. In system 100, if a command is issued by a driver to a NIC hardware device, and the NIC hardware device is not configured to perform the command or does not recognize the command, the NIC hardware device may not perform the command. A general purpose processor may not be available to perform the command.

In system 150, a driver can perform instruction-level analysis of a DSL program and translate the DSL program into a format for execution by the NIC hardware device and offload processing of instructions to a processor to handle an exception path or exceptional path. At (1), the driver’s control path accepts packet filter logic operations, described by a DSL, and cause performance of parser emulation of the DSL program. Examples of DSL include Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, or others. For example, the driver can be based on Linux® kernel, Microsoft® Windows or Server, Data Plane Development Kit (DPDK), or other frameworks.

At (2), the driver can analyze the DSL instructions and translate DSL instructions into a hardware command representation to be performed by the NIC hardware. Translating DSL instructions into a hardware command representation can include one or more of the following operations: (1) DSL command analysis, (2) a rule sculpting, (3) emulating operation of a parser of the NIC, and (4) loading a parser logic representation into the NIC hardware. In some examples, a firmware can provide driver with access to a parser logic representation that specifies operations performed by a parser of packet processing pipeline 352. The driver can configure NIC with rules that NIC hardware can perform but if NIC hardware cannot perform operations of a DSL instruction, NIC hardware can cause such operations to be performed by a General-Purpose Processor (GPP) (e.g., a CPU or processor). At (3), the driver can set up the GPP to perform exception path handling for certain packet filter logic of the DSL program. In some examples, NIC hardware or network interface device can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance (e.g., storage, memory, accelerator, processors, and/or security). While examples are described with respect to a NIC, the technologies described herein can be used for other devices, such as accelerators, storage controllers, memory controllers, image processing devices, graphics processing units (GPUs), or other devices.

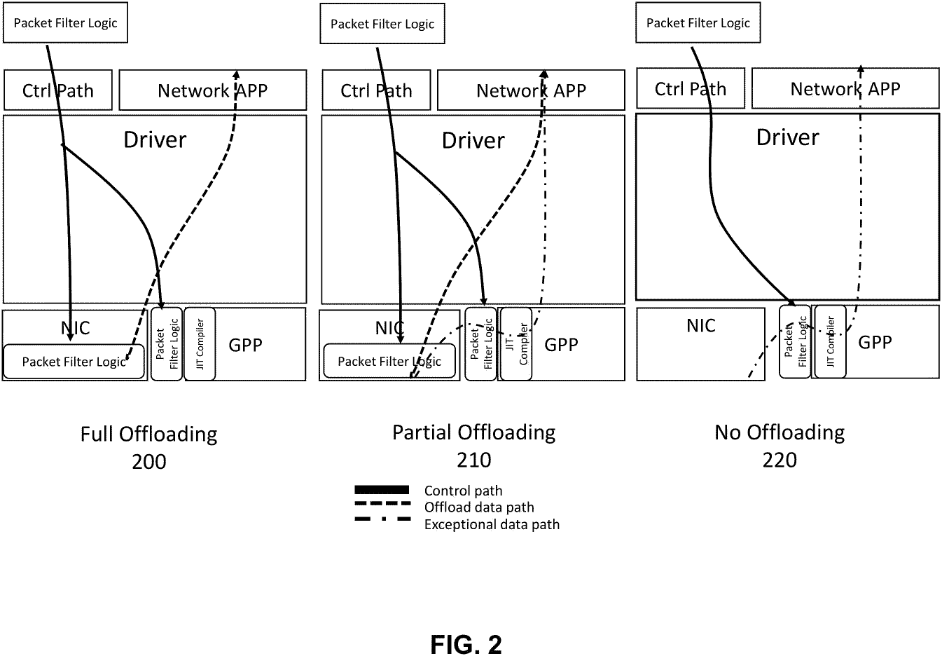

FIG. 2 depicts an example overview of capabilities that can be performed by a NIC. In configuration 200, full offloading can include causing operations specified by a DSL program to be performed by a NIC hardware. In configuration 210, partial offloading can include causing operations specified by a DSL program to be performed by a NIC hardware with some exceptions being performed by GPP. In configuration 220, no offloading can include no operations specified by a DSL program being performed by NIC hardware and instead being performed by the GPP.

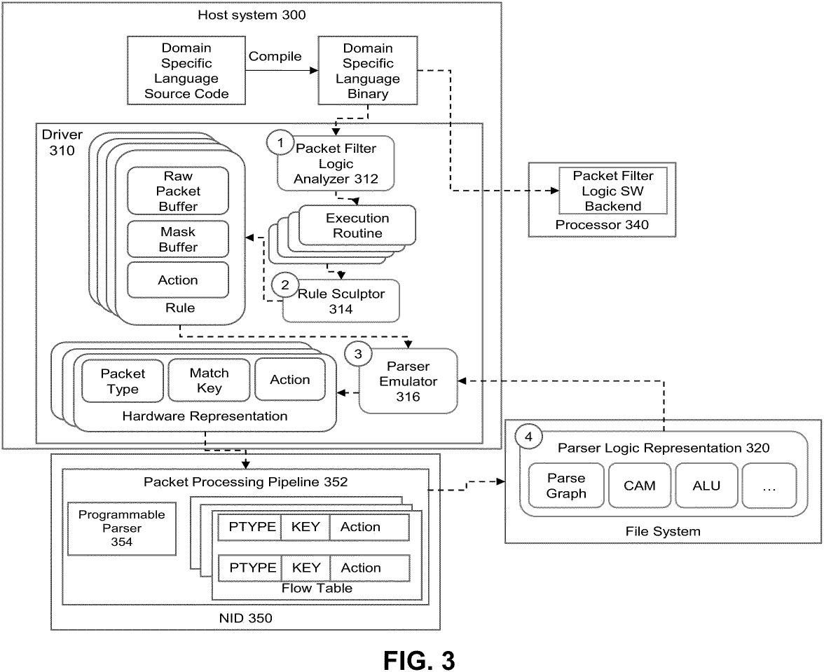

FIG. 3 depicts an example system and operation. A developer can create a packet filter represented as DSL source code. After compiling of the DSL program, driver 310 can translate the compiled DSL program into intermediate format and translate the intermediate format to hardware configuration (e.g., packet type and match-action rules) to be performed by packet processing pipeline 352 of network interface device (NID) 350. For example, driver 310 can be implemented based on a software library such as (DPDK), OpenDataPlane (ODP), Infrastructure Programmer Development Kit (IPDK), or others.

In driver 310, at (1), packet filter logic analyzer 312 can process compiled DSL binary to perform an instruction level analysis and generate a representation of the DSL binary as a set of execution routines. For example, the packet filter logic analyzer 312 can generate execution routine representations of a compiled DSL program for different domain-specific languages. In driver 310, at (2), rule sculptor 314 can determine packet modification and mask locations corresponding packet modifications as well as actions based on execution routine representations.

In driver 310, at (3), parser emulator 316 can emulate parser 354 based on parser logic representation 320 to identify packet type, match key, and actions for packet modification and mask locations. Parser emulator 316 can emulate precise operation of parser 354 based on parser logic representation 320 from a file system or other source. For example, parser logic representation 320 can represent a manner that parser 320 navigates bits of a packet based on numerical bit offsets from start of packet and numerical bit offsets from start of a field to identify and provide values of different fields for particular packet types (e.g., IPv4, Transmission Control Protocol (TCP), User Datagram Protocol (UDP), as well as other varieties of packets and packet nestings). For example, based on configuration of parser logic representation 320, parser emulator 316 can translate a rule generated by rule sculptor 314 into a flow rule that can be performed by programmable parser 354. For example, based on packet values and corresponding mask generated by rule sculptor 314 and configuration by parser logic representation 320, parser emulator 316 can generate a rule profile that specifies actions based on matches of particular values of fields of a packet. For example, a flow rule can include specification of a packet type (PTYPE), match key, and action. Examples of packet types include IPv4/TCP, IPv4/ UDP, MAC/IPv4/GTPU/IPV4, or other packets and protocols.

In some examples, emulation of actions of parser 354 may not be performed, and emulation can include analysis to determine operations performed by parser 354 based on rules from rule sculptor 314 and configure parser 354 to perform rules from rule sculptor 314.

Driver 310 can cause an action for a rule to be provided to NID 350 or firmware via a control channel either to NID 350 or firmware directly. For example, for a switch block, an action could be provided by a control queue command, direct write to NID 350, or other side-band communication.

Parser emulator 316 can indicate an exception case to be handled by processor 340 based on no rule being available to configure packet processing pipeline 352 or a rule being specified in the DSL binary. For example, parser emulator 316 can reject a flow rule if the packet buffer cannot be parsed as a valid packet type and cause processing of packets of that invalid packet type to be processed by processor 340 or other processor.

Driver 310 can provide a flow rule to NID 350 via an interface to configure a flow table that controls operation of packet processing pipeline 352.

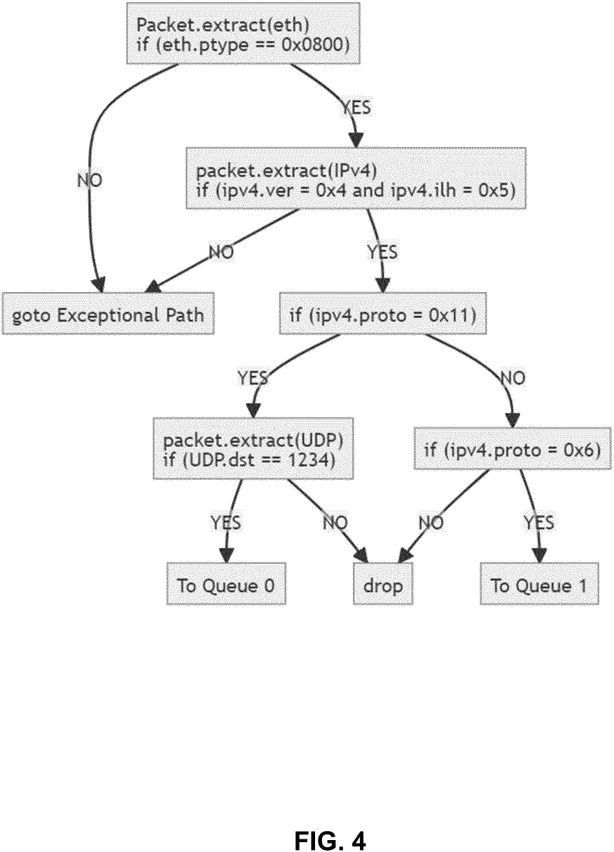

FIG. 4 depicts an example parse graph representation of DSL program execution routines. For example, one or more execution routines can be represented as parse graphs of a tree format with branches, identifying decision logic, jumps, and conditional value assignments and parser rules. Parser 354 can identify and provide particular content (bits or bytes) offset from start of packet. For example, packet filter logic analyzer 312 of driver 310 can process packet filter logic described by a DSL program and output a collection of code execution trees with paths from root to leaf of execution routines expressed as rules that can be performed by parser 354 or as exceptions by a general purpose processor.

In the example of FIG. 4, an execution routine can be represented as a tree with yes/no branches. Branch directions can be based on packet type and field values for IPv4 and UDP protocol packets. Based on meeting certain conditions, an exception path can be taken or the packet can be stored to a queue 0 or queue 1 or the packet can be dropped.

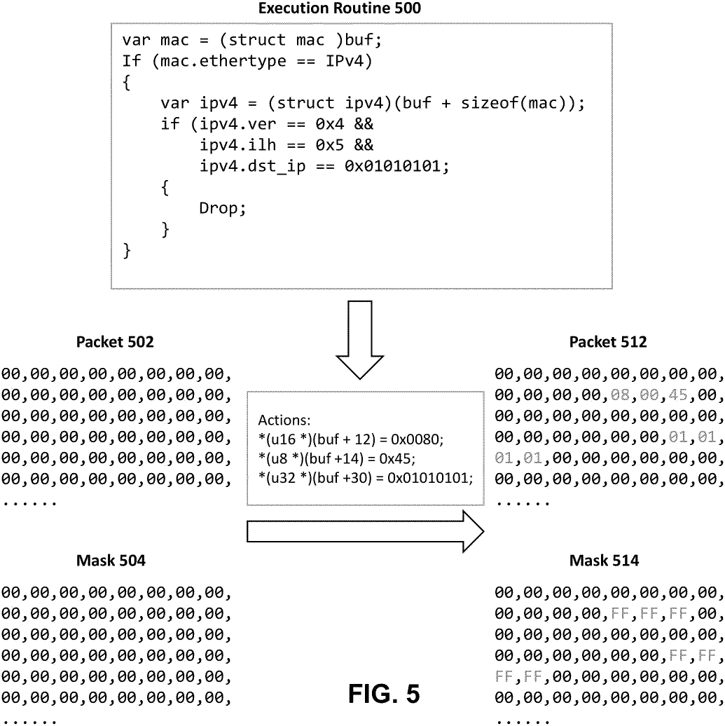

FIG. 5 depicts an example of rule sculpturing. For example, driver 310 can utilize rule sculptor 314 to process one or more execution routines (e.g., execution routine 500) and generate a packet and mask buffer pair that can be provided to parser emulator 316. For example, to process one or more execution routines and generate a packet and mask buffer pair, rule sculptor 314 can perform operations including one or more of: (1) select an execution routine and initialize a pair of buffers with zero patterns; (2) perform an emulation on the execution routine to insert values into positions in packet and mask buffers that are monitored by execution routine to generate a set of match values for particular offsets; and/or (3) determine packet contents and mask buffer contents and corresponding actions. Packet contents can indicate values of particular fields that correspond to zero or non-zero offsets in the associated mask.

For example, rule sculptor can access an execution routine generated by packet filter logic analyzer and determine how a packet processing pipeline is going to modify the packet and corresponding offsets to modified fields (e.g., non-zero fields). Rule sculptor can process the instructions of the execution routine to identify condition check instructions and generate a set of packet modification actions that lead to modified fields of the packet. A first buffer can include empty packet 502 and a second buffer can include a blank mask 504. Based on execution routine 500, packet modification actions can be applied on the empty buffers to generate modified packet 512 and mask buffer 514, which identifies locations of packet 502 that were modified by execution routine 500. Rule sculptor can determine offsets in packet 512 that correspond to modified header field values. The example of FIG. 5 shows formation of packet values and a corresponding mask that identifies locations of packet values from an execution routine that results in action of dropping an IPv4 packet with destination IP of 1.1.1.1.

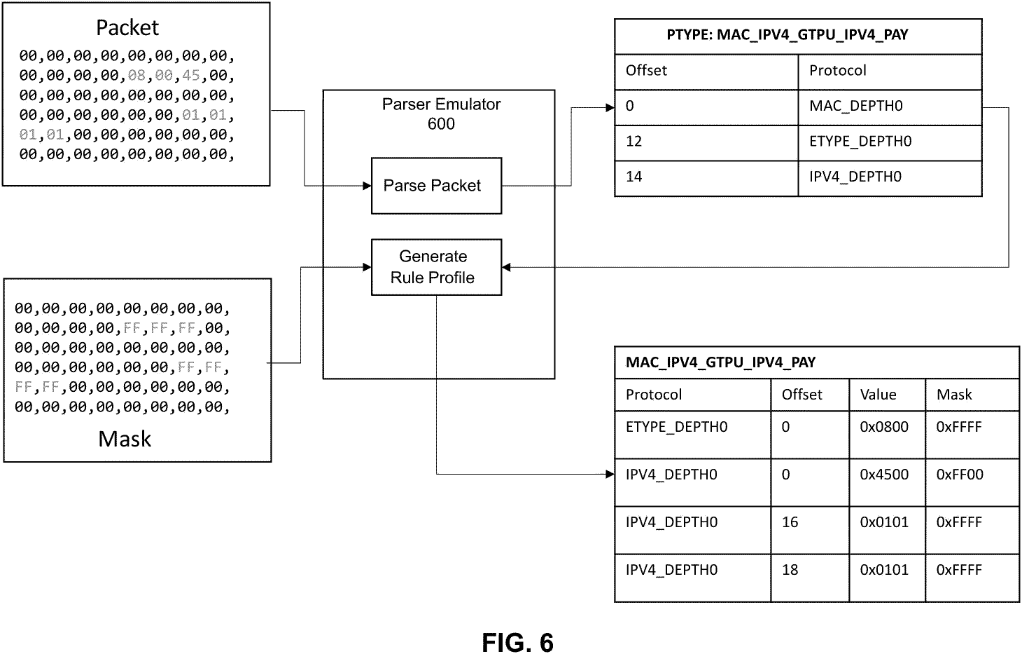

FIG. 6 depicts an example operation of a parser emulator to generate a rule that can configure the network interface device. In this example, a packet buffer, generated by rule sculptor, can be parsed by parser emulator 600 according to the parser logic representation to identify packet values (e.g., hexadecimal values) at particular positions in the packet, offset in bytes from a packet start. For example, a packet of packet type (e.g., packet layout) of media access control (MAC)/IPv4/GTPU/IPv4/payload in the packet buffer, value 0×0800 can correspond to a value of field ETHERTYPE (ETYPE_DEPTH0) whereas value 0×4500 can correspond to a value of field IPV4_DEPTH0. Based on the mask and packet buffer, generated by the rule sculptor, a rule profile can be generated by parser emulator 600 to identify values of 0×0800 for field ETYPE_DEPTH0, 0×4500 for IPV4_DEPTH0, 0×0101 for IPV4_DEPTH0 offset 16 bytes from 0×4500 for IPV4_DEPTH0, and 0×0101 for IPV4_DEPTH0 offset 18 bytes from 0×4500 for IPV4_DEPTH0. Parser emulator 600 can generate a flow rule with packet type, byte offset, and match actions generated by rule sculptor 314.

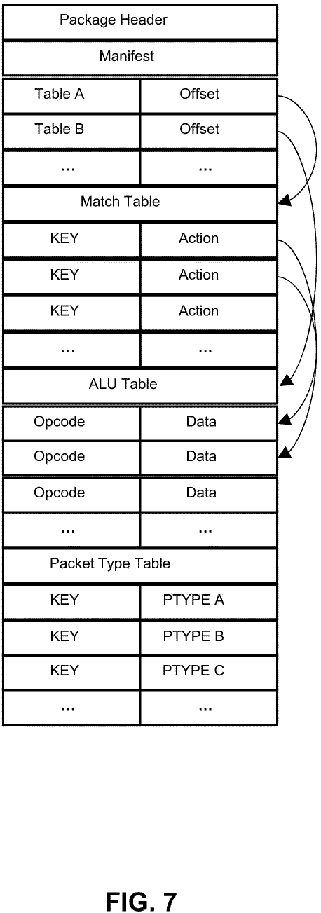

FIG. 7 depicts an example of parser logic representation file. Other parser configurations can be applied. Parser logic representation file can specify a configuration utilized by parser 354 for jumping a specified offset number of bytes from a start or other location in the packet to read particular values corresponding to particular header fields based on a packet type. Parsing can include retrieval of key-action, opcode-data, and key-packet type from a content addressable memory (CAM) or random access memory (RAM). For example, Table A and Table B can identify offsets into the parser logic representation file to a match table for respective packet type A and packet type B. Match Table can include particular key-actions to identify actions for a particular value in a field as well as an offset in the parser logic representation file to an arithmetic logic unit (ALU) table. In ALU Table, opcode-data pairs can cause jumping to a next field to read the next field. PacketType Table can identify various packet types.

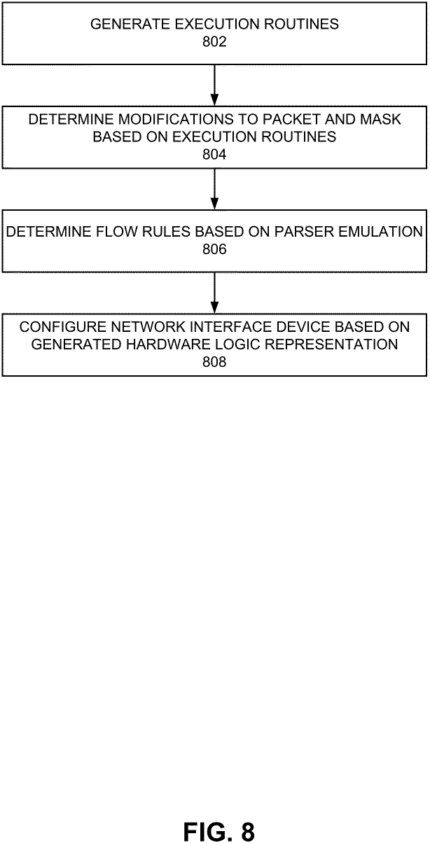

FIG. 8 depicts an example process. The process can be performed by a driver executed by a processor. At 802, the driver can generate a set of one or more execution routines to run on hardware based on a compiled domain specific binary. At 804, the driver can determine modifications of a packet and mask identifying locations of packet modifications and actions based on the set of one or more execution routines. At 806, the driver can perform emulation of a parser of a network interface device according to the parser logic to determine packet type and match-action rules based on the packet modifications and packet mask. At 808, the driver can configure the network interface device with the packet type and match-action flow rules to configure operation of the parser and packet processing pipeline. Thereafter, the network interface device can perform operations based on the flow rules, including offloading operations to a processor or accelerator.

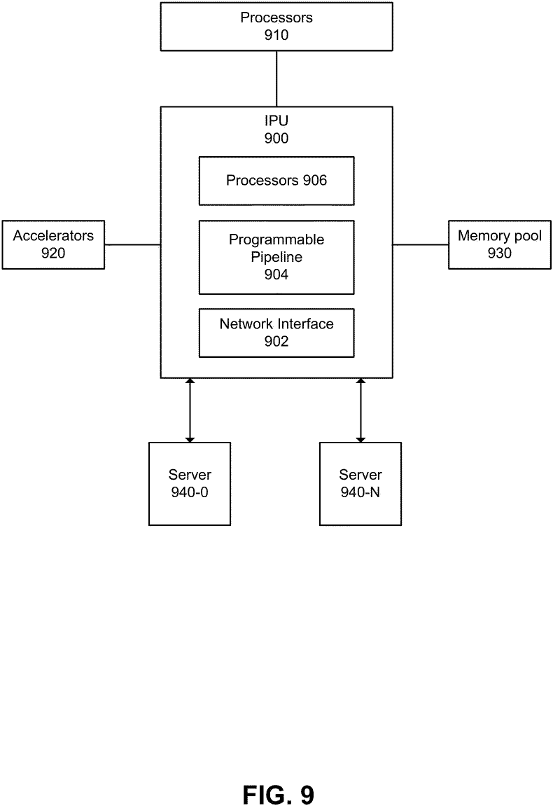

FIG. 9 depicts an example network interface device. In this system, IPU 900 manages performance of one or more processes using one or more of processors 906, processors 910, accelerators 920, memory pool 930, or servers 940-0 to 940-N, where N is an integer of 1 or more. In some examples, processors 906 of IPU 900 can execute one or more processes, applications, VMs, containers, microservices, and so forth that request performance of workloads by one or more of: processors 910, accelerators 920, memory pool 930, and/or servers 940-0 to 940-N. IPU 900 can utilize network interface 902 or one or more device interfaces to communicate with processors 910, accelerators 920, memory pool 930, and/or servers 940-0 to 940-N. IPU 900 can utilize programmable pipeline 904 to process packets that are to be transmitted from network interface 902 or packets received from network interface 902.

Programmable pipeline 904, processors 906, accelerators 920 can include a programmable processing pipeline or offload circuitries that is programmable by P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, ×86 compatible executable binaries or other executable binaries. A programmable processing pipeline can include one or more circuitries that perform match-action operations in a pipelined or serial manner that are configured based on a programmable pipeline language instruction set. Processors, FPGAs, other specialized processors, controllers, devices, and/or circuits can be used utilized for packet processing or packet modification. Ternary content-addressable memory (TCAM) can be used for parallel match-action or look-up operations on packet header content. Programmable pipeline 904 and/or processors 906 can be configured to perform packet processing based on a flow rule configuration from a driver, as described herein.

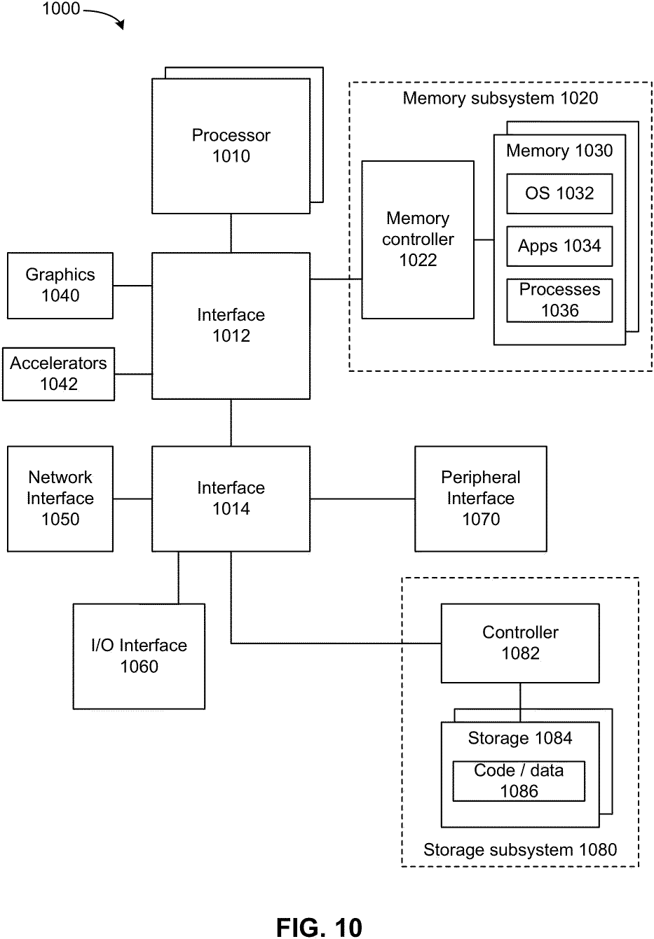

FIG. 10 depicts an example computing system that can be used in a server or data center. Components of system 1000 (e.g., processor 1010, accelerators 1042, and so forth) to perform operations translated by a driver, as described herein. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 1040 interfaces to graphics components for providing a visual display to a user of system 1000. In one example, graphics interface 1040 generates an image or video or display or storage based on data stored in memory 1030 or based on operations executed by processor 1010 or both.

Accelerators 1042 can be a fixed function or programmable offload engine that can be accessed or used by a processor 1010. For example, an accelerator among accelerators 1042 can provide compression (DC) capability, cryptography services such as public key encryption (PKE), cipher, hash/authentication capabilities, decryption, or other capabilities or services. In some embodiments, in addition or alternatively, an accelerator among accelerators 1042 provides field select controller capabilities as described herein. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. For example, OS 1032 can include or access a driver that is to translate instructions for execution by one or more devices, as described herein.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can perform operations to update mappings of received packets to target processes or devices can be updated, as described herein.

Some examples of network interface 1050 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 can include volatile or non-volatile memory. A volatile memory is memory whose state (and therefore the data stored in it) is indeterminate if power is interrupted to the device. An example of a volatile memory include a cache. A non-volatile memory (NVM) device is a memory whose state is determinate even if power is interrupted to the device.

In an example, system 1000 can be implemented using interconnected compute nodes of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chip-to-chip communications, chiplet-to-chiplet communications, die-to-die communications, packet-based communications, communications over a device interface, fabric-based communications, and so forth. A die-to-die communications can be consistent with Embedded Multi-Die Interconnect Bridge (EMIB).

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples and includes a non-transitory computer-readable medium comprising instructions stored thereon, that if executed by one or more processors, cause the one or more processors to: execute a driver that is to: determine a configuration of a packet processing pipeline of a network interface device to perform an instruction set written in a domain specific language (DSL) for the packet processing pipeline based on emulation of a parser of the packet processing pipeline and provide the configuration to the packet processing pipeline of the network interface device to specify operations of the packet processing pipeline of the network interface device.

Example 2 includes one or more examples, wherein the emulation of the parser of the packet processing pipeline is based on a parser logic configuration utilized by the parser of the packet processing pipeline and wherein the parser logic configuration specifies at least one offset into the packet corresponding to at least one header field for a particular packet type.

Example 3 includes one or more examples, wherein the particular packet type is associated with particular arrangements and locations of header fields and definitions of header field values according to at least one protocol.

Example 4 includes one or more examples and includes instructions stored thereon, that if executed by one or more processors, cause the one or more processors to: execute the driver to: generate one or more code execution tree representations of the instruction set.

Example 5 includes one or more examples and includes instructions stored thereon, that if executed by one or more processors, cause the one or more processors to: execute the driver to: apply the instruction set to a packet buffer and mask buffer to generate a modified packet and corresponding mask with locations of packet modifications based on actions specified in the instruction set.

Example 6 includes one or more examples, wherein the emulation of a parser of the packet processing pipeline is based on the generated modified packet and corresponding mask.

Example 7 includes one or more examples, wherein the configuration comprises one or more of: a packet type, key, and action.

Example 8 includes one or more examples, wherein the configuration specifies at least one exception case to be processed by a processor.

Example 9 includes one or more examples, wherein the DSL comprises one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), or eBPF.

Example 10 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Example 11 includes one or more examples, and includes an apparatus comprising: a network interface device comprising a programmable packet processing pipeline, wherein the programmable packet processing pipeline comprises a packet parser and wherein configuration of the programmable packet processing pipeline is based on a driver-generated configuration based on emulation of the parser during execution of an instruction set written in a domain specific language (DSL) for the programmable packet processing pipeline.

Example 12 includes one or more examples, wherein the emulation of the parser of the programmable packet processing pipeline is based on a parser logic configuration utilized by the parser of the programmable packet processing pipeline and wherein the parser logic configuration is to specify at least one offset into the packet corresponding to at least one header field for a particular packet type.

Example 13 includes one or more examples, wherein the particular packet type is associated with particular arrangements and locations of header fields and definitions of header field values according to at least one packet format.

Example 14 includes one or more examples, wherein the programmable packet processing pipeline comprises circuitries that perform match-action operations in a pipelined manner.

Example 15 includes one or more examples, wherein the configuration comprises one or more of: a packet type, key, and action.

Example 16 includes one or more examples, wherein the configuration is to specify an exception case to be processed by a processor.

Example 17 includes one or more examples, and includes a server communicatively coupled to the network interface device, wherein the server is to execute the driver.

Example 18 includes one or more examples, and includes a method comprising: a driver performing: determining a configuration of a packet processing pipeline of a network interface device to perform an instruction set written in a domain specific language (DSL) for the packet processing pipeline based on emulation of a parser of the packet processing pipeline and providing the configuration to the packet processing pipeline of the network interface device to specify operation of the packet processing pipeline of the network interface device.

Example 19 includes one or more examples, wherein the emulation of a parser of the packet processing pipeline is based on a parser logic configuration utilized by the parser of the packet processing pipeline and wherein the parser logic configuration specifies at least one offset into the packet corresponding to at least one header field for a particular packet type.

Example 20 includes one or more examples, wherein the particular packet type is associated with particular arrangements and locations of header fields and definitions of header field values for a particular packet format.

What is claimed is:

1. A non-transitory computer-readable medium comprising instructions stored thereon, that if executed by one or more processors, cause the one or more processors to:
execute a driver that is to:
determine a configuration of a packet processing pipeline of a network interface device to perform an instruction set written in a domain specific language (DSL) for the packet processing pipeline based on emulation of a parser of the packet processing pipeline and
provide the configuration to the packet processing pipeline of the network interface device to specify operations of the packet processing pipeline of the network interface device.

2. The computer-readable medium of claim 1, wherein the emulation of the parser of the packet processing pipeline is based on a parser logic configuration utilized by the parser of the packet processing pipeline and wherein the parser logic configuration specifies at least one offset into the packet corresponding to at least one header field for a particular packet type.

3. The computer-readable medium of claim 2, wherein the particular packet type is associated with particular arrangements and locations of header fields and definitions of header field values according to at least one protocol.

4. The computer-readable medium of claim 1, comprising instructions stored thereon, that if executed by one or more processors, cause the one or more processors to:
execute the driver to:
generate one or more code execution tree representations of the instruction set.

5. The computer-readable medium of claim 1, comprising instructions stored thereon, that if executed by one or more processors, cause the one or more processors to:
execute the driver to:
apply the instruction set to a packet buffer and mask buffer to generate a modified packet and corresponding mask with locations of packet modifications based on actions specified in the instruction set.

6. The computer-readable medium of claim 5, wherein the emulation of a parser of the packet processing pipeline is based on the generated modified packet and corresponding mask.

7. The computer-readable medium of claim 1, wherein the configuration comprises one or more of: a packet type, key, and action.

8. The computer-readable medium of claim 1, wherein the configuration specifies at least one exception case to be processed by a processor.

9. The computer-readable medium of claim 1, wherein the DSL comprises one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), or eBPF.

10. The computer-readable medium of claim 1, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

11. An apparatus comprising:
a network interface device comprising a programmable packet processing pipeline, wherein the programmable packet processing pipeline comprises a packet parser and wherein configuration of the programmable packet processing pipeline is based on a driver-generated configuration based on emulation of the parser during execution of an instruction set written in a domain specific language (DSL) for the programmable packet processing pipeline.

12. The apparatus of claim 11, wherein the emulation of the parser of the programmable packet processing pipeline is based on a parser logic configuration utilized by the parser of the programmable packet processing pipeline and wherein the parser logic configuration is to specify at least one offset into the packet corresponding to at least one header field for a particular packet type.

13. The apparatus of claim 12, wherein the particular packet type is associated with particular arrangements and locations of header fields and definitions of header field values according to at least one packet format.

14. The apparatus of claim 12, wherein the programmable packet processing pipeline comprises circuitries that perform match-action operations in a pipelined manner.

15. The apparatus of claim 11, wherein the configuration comprises one or more of: a packet type, key, and action.

16. The apparatus of claim 11, wherein the configuration is to specify an exception case to be processed by a processor.

17. The apparatus of claim 11, comprising:
a server communicatively coupled to the network interface device, wherein the server is to execute the driver.

18. A method comprising:
a driver performing:
determining a configuration of a packet processing pipeline of a network interface device to perform an instruction set written in a domain specific language (DSL) for the packet processing pipeline based on emulation of a parser of the packet processing pipeline and
providing the configuration to the packet processing pipeline of the network interface device to specify operation of the packet processing pipeline of the network interface device.

19. The method of claim 18, wherein the emulation of a parser of the packet processing pipeline is based on a parser logic configuration utilized by the parser of the packet processing pipeline and wherein the parser logic configuration specifies at least one offset into the packet corresponding to at least one header field for a particular packet type.

20. The method of claim 19, wherein the particular packet type is associated with particular arrangements and locations of header fields and definitions of header field values for a particular packet format.
